(19) United States
(12) Patent Application Publication
(10) Pub. No.: US 2024/0265243 A1
(43) Pub. Date: Aug. 8, 2024

(54) METHOD AND SYSTEM FOR NEURAL NETWORK INFERENCING IN LOGARITHMIC DOMAIN

(71) Applicant: Tata Consultancy Services Limited, Mumbai (IN)

(72) Inventors: Archisman BHOWMICK, Thane West (IN); Mayank MISHRA, Thane West (IN); Rekha SINGHAL, Thane West (IN); Aditya Singh RATHORE, Nagaur (IN)

(73) Assignee: Tata Consultancy Services Limited, Mumbai (IN)

(21) Appl. No.: 18/422,076

(22) Filed: Jan. 25, 2024

(30) Foreign Application Priority Data
Feb. 6, 2023 (IN) 202321007570

(51) Int. Cl. G06N 3/048

(52) U.S. Cl. CPC G06N 3/048

(57) ABSTRACT

This disclosure relates generally to neural network inferencing, and more particularly, to a method and system for neural network inferencing in logarithmic domain. The conventional techniques include training a neural network in logarithmic domain and performing inferencing. This leads to less accuracy, challenge in converting large models and unable to perform optimization. The present disclosure converts a pre-trained neural network into logarithmic domain using a bit manipulation based logarithm number system technique wherein the neural network is pre-trained in real time or in logarithmic domain. The method converts the weights, neural network layers and activation function into logarithmic domain. The method uses a 32-bit integer variable to store a logarithm number which leads to memory efficiency. The disclosed method is used for inferencing of convolutional neural network for natural language processing, image recognition and so on.

### PRIORITY CLAIM

This U.S. patent application claims priority under 35 U.S.C. § 119 to: Indian Patent Application No. 202321007570, filed on Feb. 6, 2023. The entire contents of the aforementioned application are incorporated herein by reference.

### TECHNICAL FIELD

The disclosure herein generally relates to neural network inferencing, and, more particularly, to a method and system for neural network inferencing in logarithmic domain.

### BACKGROUND

In recent years, neural networks (NNs) like deep neural networks, convolutional neural networks and so on have been used in a range of cognitive applications, such as natural language processing and image recognition. Increasing dataset, model size and the desire to run DNNs on resource constrained edge devices have motivated researchers to optimize their hardware implementation. The DNN computation involves multiply-accumulate (MAC) operations. Since the multiplier circuitry dominates the complexity of MAC, several techniques have been proposed to optimize the multiplication operations in the MAC units.

It is known that multiplication operation in the real domain transforms into addition operation in the logarithm domain. Since addition operation incurs lower overhead than multiplication, several methods have used a logarithmic domain number system (LNS) for optimizing inference of neural networks. The logarithmic domain gives a larger range for small real domain magnitude numbers, which is the case for deep learning model parameters. Using a logarithm number system also avoids the problems inherent in the residue number system (RNS).

Prior methods propose training the neural network model in the logarithmic domain. However, training the model in the logarithmic domain is challenging due to the complexity of the training process (especially for largescale models) and the need for high accuracy. Further, training a model in the logarithmic domain may make it challenging to apply post-training optimization techniques provided by deep learning frameworks such as pruning and quantization. Further performing both training and inferencing in logarithmic domain has several problems like unable to convert large scale models, less accuracy, unable to perform quantization and so on. Also, methods performing training in logarithmic domain can convert a limited number of layers and activation functions in the model.

### SUMMARY

Embodiments of the present disclosure present technological improvements as solutions to one or more of the above-mentioned technical problems recognized by the inventors in conventional systems. For example, in one embodiment, a method for neural network inferencing in logarithmic domain is provided. The method includes receiving a neural network (NN) comprising (i) a plurality of neural network weights, (ii) a plurality of neural network layers comprising a plurality of neural network layer-wise operations and (iii) a plurality of activation functions in an activation layer of the NN. Further the method includes converting the NN into logarithmic domain to obtain a logarithmic neural network using a Bit Manipulation based Logarithmic Number System (BMLNS) technique. The step of converting the NN includes converting the plurality of neural network weights of the NN into logarithmic domain and converting the plurality of neural network layers and the plurality of activation functions into logarithmic domain. Furthermore, the method includes performing NN inference with an input data to obtain a set of output using the logarithmic neural network wherein the input data is converted into logarithmic domain using the BMLNS technique.

In another aspect, a system for neural network inferencing in logarithmic domain is provided. The system comprises memory storing instructions; one or more communication interfaces; and one or more hardware processors coupled to the memory via the one or more communication interfaces, wherein the one or more hardware processors are configured by the instructions to receive a NN comprising (i) a plurality of neural network weights, (ii) a plurality of neural network layers comprising a plurality of neural network layer-wise operations and (iii) a plurality of activation functions in an activation layer of the NN. Further the system includes to convert the NN into logarithmic domain to obtain a logarithmic neural network using a BMLNS technique. The step of converting the NN includes converting the plurality of neural network weights of the NN into logarithmic domain and converting the plurality of neural network layers and the plurality of activation functions into logarithmic domain. Furthermore, the system includes to perform NN inference with an input data to obtain a set of output using the logarithmic neural network wherein the input data is converted into logarithmic domain using the BMLNS technique.

The NN is pre-trained in one of (i) a real domain and (ii) the logarithmic domain. The BMLNS technique on a real number(x) is denoted by,

$$mag = log ( \vert x \vert ) \\ number = ( ( int ( \vert mag \vert \times {2}^{n} ) \times 2 + sign ) \times 2 + iszero ) \\ BMLNS = \{ \begin{matrix}number , & if mag \geq 0 \\ - ( number ) , & otherwise\end{matrix}$$

where, sign denotes sign of the real number, iszero denotes the real number is zero or otherwise, mag is the magnitude of logarithmic number system representation of the real number and n is a positive integer decided on real time based on the granularity and distribution of neural network weights of the pre-trained NN. The real number is transformed to a single 32-bit integer using the bit manipulation based logarithmic number system. The single 32-bit integer of the real number comprises, a least significant bit (LSB) denoting the real number is zero or otherwise; a bit before LSB denoting sign of the real number; and remaining bits denoting integer value of magnitude of logarithm function of the real number.

The plurality of neural network layers includes an input layer, a dense layer, a convolution layer, a max-pooling layer, a batch normalization layer, an activation layer, a Long Short Term Memory (LSTM) layer. The plurality of activation functions includes an argmax function, a Rectified Linear Unit (ReLU) function, a sigmoid and a tanh function. The plurality of activation functions is converted utilizing anyone of (i) BMLNS technique or (ii) a pre-computed lookup table.

In yet another aspect, there is provided a computer program product comprising a non-transitory computer readable medium having a computer readable program embodied therein, wherein the computer readable program, when executed on a computing device causes the computing device for neural network inferencing in logarithmic domain by receiving a NN comprising (i) a plurality of neural network weights, (ii) a plurality of neural network layers comprising a plurality of neural network layer-wise operations and (iii) a plurality of activation functions in an activation layer of the NN. Further the computer readable program includes converting the NN into logarithmic domain to obtain a logarithmic neural network using a BMLNS technique. The step of converting the NN includes converting the plurality of neural network weights of the NN into logarithmic domain and converting the plurality of neural network layers and the plurality of activation functions into logarithmic domain. Furthermore, the computer readable program includes performing NN inference with an input data to obtain a set of output using the logarithmic neural network wherein the input data is converted into logarithmic domain using the BMLNS technique.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary block diagram of a system for neural network inferencing in logarithmic domain according to some embodiments of the present disclosure.

FIG. 2 is a schematic diagram depicting broad-level process flow of neural network inferencing in logarithmic domain according to some embodiments of the present disclosure.

FIG. 3A and FIG. 3B is an exemplary flow diagram of a method for neural network inferencing in logarithmic domain in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

In Artificial Intelligence (AI) multiplications are responsible for a significant overhead in hardware accelerators. Since multiplications in the real domain transform into addition in the logarithmic domain, logarithmic number system (LNS) is used for inference. Since the log value of a negative number and zero is undefined, conventional techniques need to store the magnitude, sign and iszero flag separately as three separate variables. LNS of a real number x is represented by the logarithm of its absolute values (the magnitude), its sign and a flag called iszero, which notifies whether the real number is zero. Such an approach may lead to a larger memory.

The embodiments of the present disclosure, provides a method for neural network inferencing in logarithmic domain. In the context of the present disclosure, the expressions ‘neural network (NN)’ and ‘model’ may be used interchangeably. The disclosed method works for neural networks trained in real domain or those trained in logarithmic domain. The embodiments of the present disclosure, converts a trained model to logarithmic domain after it is pruned or undergone another optimization. The method provides a bit manipulation based logarithm number system technique for storing logarithmic numbers of real numbers. The disclosed method is complementary to other NN complexity reduction techniques, such as pruning. The range of parameter values are known once the model is trained. Based on this, the number of bits needed to represent them in the logarithmic domain can be configured and the disclosed method utilizes a 32-bit integer variable for storing the logarithm number of a real number. This enables instance optimized deployment of the model on edge devices.

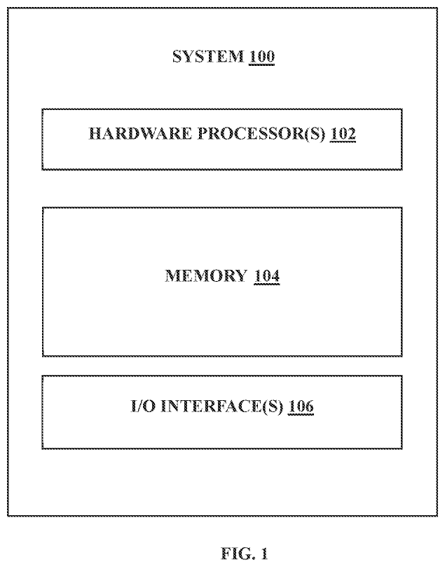

Referring now to the drawings, and more particularly to FIG. 1 through FIG. 3B, where similar reference characters denote corresponding features consistently throughout the figures, there are shown preferred embodiments and these embodiments are described in the context of the following exemplary system and/or method.

FIG. 1 illustrates an exemplary block diagram of a system 100 for neural network inferencing in logarithmic domain according to some embodiments of the present disclosure. In an embodiment, the system 100 includes one or more hardware processors 102, communication interface(s) or input/output (I/O) interface(s) 106, and one or more data storage devices or memory 104 operatively coupled to the one or more processors 102. The one or more hardware processors 102 that are hardware processors can be implemented as one or more microprocessors, microcomputers, microcontrollers, digital signal processors, central processing units, state machines, graphics controllers, logic circuitries, and/or any devices that manipulate signals based on operational instructions. Among other capabilities, the processor(s) are configured to fetch and execute computer-readable instructions stored in the memory. In the context of the present disclosure, the expressions ‘processors’ and ‘hardware processors’ may be used interchangeably. In an embodiment, the system 100 can be implemented in a variety of computing systems, such as laptop computers, notebooks, hand-held devices, workstations, mainframe computers, servers, a network cloud and the like.

The I/O interface (s) 106 may include a variety of software and hardware interfaces, for example, a web interface, a graphical user interface, and the like and can facilitate multiple communications within a wide variety of networks and protocol types, including wired networks, for example, LAN, cable, etc., and wireless networks, such as WLAN, cellular, or satellite. In an embodiment, the I/O interface(s) can include one or more ports for connecting a number of devices to one another or to another server.

The memory 104 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

In an embodiment, the memory 104 includes a plurality of modules such as the pre-trained NN, the logarithmic NN model and so on (not shown). The plurality of modules includes programs or coded instructions that supplement applications or functions performed by the system 100 for executing different steps involved in the process of NN inferencing being performed by the system 100. The plurality of modules, amongst other things, can include routines, programs, objects, components, and data structures, which performs particular tasks or implement particular abstract data types. The plurality of modules may also be used as, signal processor(s), node machine(s), logic circuitries, and/or any other device or component that manipulates signals based on operational instructions. Further, the plurality of modules can be used by hardware, by computer-readable instructions executed by the one or more hardware processors 102, or by a combination thereof. The plurality of modules can include various sub-modules (not shown).

Further, the memory 104 may include a database or repository which may store the pre-trained NN. The memory 104 may comprise information pertaining to input(s)/output(s) of each step performed by the processor(s) 102 of the system 100 and methods of the present disclosure. In an embodiment, the database may be external (not shown) to the system 100 and coupled via the I/O interface 106.

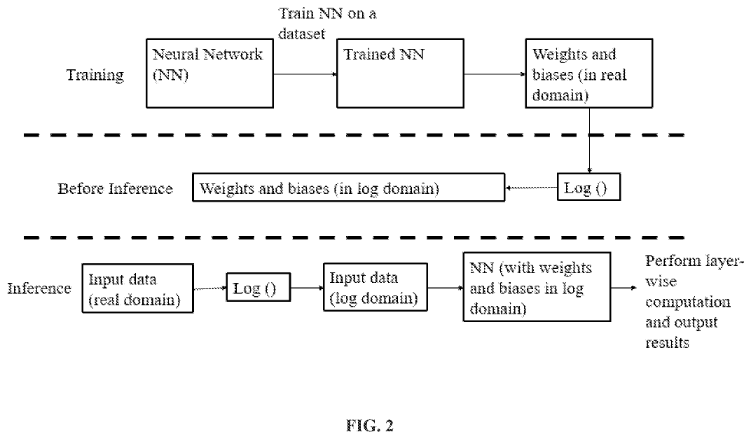

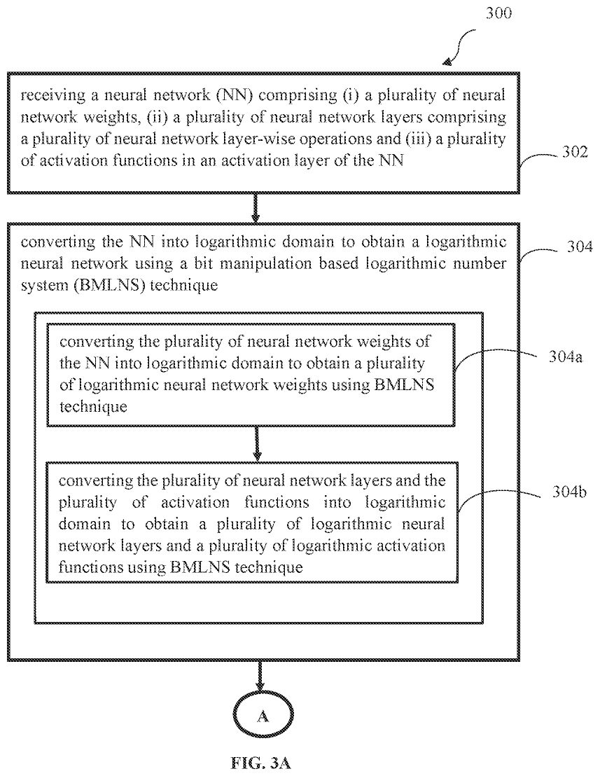

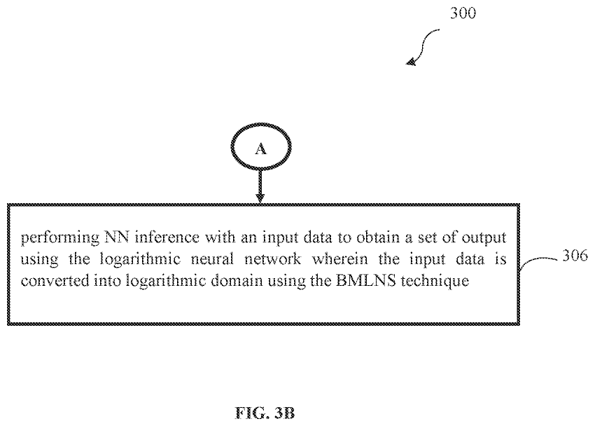

FIG. 2 is a schematic diagram depicting broad-level process flow of neural network inferencing in logarithmic domain according to some embodiments of the present disclosure. As depicted in the figure, the process flow includes three phases, training, before inference and inference phases. In the training phase, a NN is trained utilizing a dataset in real domain to obtain a trained NN. The NN is trained in real domain to obtain weights and biases of the trained NN in real domain. Further in before inference phase, the trained NN is converted into logarithmic domain to obtain a logarithmic NN model by converting the weights and biases of the trained NN in real domain into logarithmic domain using a Bit Manipulation based Logarithmic Number System (BMLNS) technique. Thereafter, in the inference phase, the logarithmic NN model is used for inferencing. Here, an input data in real domain which is used for inferencing is first converted into logarithmic domain. The logarithmic input data is provided to the logarithmic NN model for inferencing to obtain output. FIG. 2 will be explained in detail in conjunction with the flow diagram depicted in FIGS. 3A and 3B.

FIG. 3A through FIG. 3B is an exemplary flow diagram of a method 300 for neural network inferencing in logarithmic domain in accordance with some embodiments of the present disclosure.

In an embodiment, the system 100 comprises one or more data storage devices or the memory 104 operatively coupled to the one or more hardware processor(s) 102 and is configured to store instructions for execution of steps of the method 300 by the processor(s) or one or more hardware processors 102. The steps of the method 300 of the present disclosure will now be explained with reference to the components or blocks of the system 100 as depicted in FIG. 1 and the steps of flow diagram as depicted in FIGS. 3A and 3B. Although process steps, method steps, techniques or the like may be described in a sequential order, such processes, methods, and techniques may be configured to work in alternate orders. In other words, any sequence or order of steps that may be described does not necessarily indicate a requirement that the steps to be performed in that order. The steps of processes described herein may be performed in any order practical. Further, some steps may be performed simultaneously.

At step 302 of the method 300, the one or more hardware processors 102 are configured to receive a NN. The NN is a pre-trained model which is pre-trained either in real domain or in logarithmic domain. The NN comprises (i) a plurality of neural network weights, (ii) a plurality of neural network layers comprising a plurality of neural network layer-wise operations and (iii) a plurality of activation functions in an activation layer of the NN. The plurality of neural network weights, the plurality of neural network layers and the activation functions may be in real domain or logarithmic domain. These are in real domain, if the NN is pre-trained in real domain else in logarithmic domain otherwise. The plurality of neural network layers includes but not limited to an input layer, a dense layer, a convolution layer, a max-pooling layer, a batch normalization layer, an activation layer, a Long Short Term Memory (LSTM) layer. The plurality of activation functions includes but not limited to an argmax function, a Rectified Linear Unit (ReLU) function, a sigmoid and a tanh function. The neural network considered in the disclosed method includes but not limited to a deep neural network, a convolutional neural network and a deep convolutional network.

At step 304 of the method 300, the one or more hardware processors 102 are configured to convert the NN into logarithmic domain to obtain a logarithmic neural network using a Bit Manipulation based Logarithmic Number System (BMLNS) technique. The conversion of the NN into logarithmic NN is explained using steps 304a and 304b. At step 304a, the plurality of neural network weights of the NN is converted into logarithmic domain to obtain a plurality of logarithmic neural network weights using BMLNS technique. At step 304b, the plurality of neural network layers and the plurality of activation functions is converted into logarithmic domain to obtain a plurality of logarithmic neural network layers and a plurality of logarithmic activation functions using BMLNS technique. Using the BMLNS technique the three values of a logarithm number, the magnitude, sign and iszero, are stored in a single 32-bit integer variable.

For a real number x, let the corresponding number in BMLNS technique be given as BMLNS(x). For computing, BMLNS(x), initially two intermediate values such as mag and number are computed. The values mag and number are represented as equations 1 and 2 respectively,

$$mag = log ( \vert x \vert ) \qquad ( 1 )$$

$$number = ( ( int ( \vert mag \vert \times {2}^{n} ) \times 2 + sign ) \times 2 + iszero ) \qquad ( 2 )$$

where, sign denotes sign of the real number, iszero denotes the real number is zero or otherwise, mag is the magnitude of the logarithmic number system representation of the real number and n is a positive integer decided on real time based on the granularity and distribution of neural network weights of the pre-trained NN. For different neural networks, the value of n can be different. For example, for LeNet, n=10 works fine, but in the case of Visual Geometry Group 16 (VGG16), n=20 is used since the distribution of weights and biases is more granular in VGG16.

Finally, BMLNS(x) is computed using equation 3 given below,

$$BMLNS = \{ \begin{matrix}number , & if mag \geq 0 \\ - ( number ) , & otherwise\end{matrix} \qquad ( 3 )$$

The least significant bit (LSB) of the single 32-bit integer denotes that the real number is zero or a non-zero number. The bit before the LSB denotes the sign of the real number and remaining bits denotes integer value of magnitude of logarithm function of the real number. However, in general BMLNS technique can also transform a real number to its logarithmic representation by storing it in an n-bit integer by manipulating the bits required to store magnitude (for example, bit-masking or any other bit-manipulation techniques can be used), where n can be any positive integer greater than 3. In this representation one bit is reserved for the iszero value, one bit is reserved for sign and the remaining n−2 bits are reserved for the magnitude part. Table 1 illustrates working of BMLNS for some sample numbers.

TABLE 1

| | | BMLNS computations | | | | |
|---|---|---|---|---|---|---|
| | | | | | Number = | |
| | mag = | k1 = | k2 = | k3 = | (k3 * 2) + | |
| x | log(\|x\|) | int(\|mag\| × 2ⁿ) | k1 * 2 | k2 + sign | iszero | BMLNS |
| −0.198676 | −1.61608 | 1654 | 3308 | 3309 | 6618 | −6618 |
| 2.0471 | 0.716424 | 733 | 1466 | 1466 | 2932 | 2932 |
| 0.172651 | −1.756482 | 1798 | 3596 | 3596 | 7192 | −7192 |
| 10.914072 | 2.390053 | 2447 | 4894 | 4894 | 9788 | 9788 |

The three values, the magnitude, sign and iszero can be computed back using the BMLNS value using equations 4, 5, 6 as given below,

$$magnitude = ( BMLNS ) \div ( {2}^{n} \times 2 \times 2 ) \qquad ( 4 )$$

$$sign = ( ( \vert BMLNS \vert ≫ 1 ) \& 1 ) \qquad ( 5 )$$

$$iszero = ( BMLNS ) \& 1 \qquad ( 6 )$$

BMLNS reduces the storage overhead. The conversion operations in both directions (converting a real number to BMLNS and vice-versa) use multiplication/division by power-of-two, which can be implemented simply by bit-shifting operations. In the case of floating-point numbers, multiplying or dividing by powers of 2, the power is added or subtracted from the exponent term of the floating-point number.

In the BMLNS technique, the different layers and activation function of the NN model are converted into logarithmic domain. The conversion of each layer is explained hereafter. In the first layer, called the input layer, the input, weight and bias matrices are converted to the logarithmic domain by converting each matrix element to 32-bit integer using the BMLNS technique. During inference, the computation of a layer produces outputs in the logarithmic domain. Thus, the input, weights, and biases are all in the logarithmic domain for the subsequent layers.

In the dense layer, the input*weight+bias operation is performed. Here, only multiplication and addition operations are converted from the real domain to the logarithmic domain. Similarly, only addition and multiplication must be converted to the Logarithm Number System (LNS) domain in the convolution layer. The pseudo code below shows the implementation details of a dense layer conversion,

```
void LNS_DenseLayer(int *A, int *W, int *answer, int *bias){
  int i, j, k;
  for(i=0;i<x;i++){
    for (j=0;j<y;j++){
      int i1=LNS_multiplication(A[i],W[j]);
      for (k=1;k<z;k++) {
        int i2= LNS_multiplication(A[k+i*z], W[j+k*y] );
        i1=addition_log(i1,i2);
      }
      answer[j+i*y]=LNS_addition(i1,bias[j]);
    }
  }
}
```

Max-pooling layer performs comparison operations. Hence, the comparison operation in the log domain has been implemented by comparing the magnitude in the log domain. The pseudo code below shows this implementation,

```
int comparison(int n1,int n2)
{
  float mag1= magnitude(n1);
  float mag2= magnitude(n2);
  int s1=sign(n1);
  int s2=sign(n2);
  if(s1==1)
  mag1= −(mag1);
  if(s2==1)
  mag2= −(mag2);
  return (mag1>=mag2)? n1:n2;
}
```

Normalization transforms the data to have a mean zero and a standard deviation one. Like other layers, four matrices from the pre-trained model are extracted for the batch normalization layer: gamma, beta, moving mean and moving variance. After converting all these matrices to the logarithmic domain, two equations below are computed,

$${h}_{i ( norm )} = \frac{( {h}_{i} - μ )}{σ + ϵ} \qquad ( 7 )$$

$$h = γ {h}_{i ( norm )} + β \qquad ( 8 )$$

γ and β are used for re-scaling and shifting, μ is the mean and σ is the standard deviation. In this layer, all four basic mathematical computations in the logarithmic domain, i.e., addition, multiplication, division, and subtraction are performed in the logarithmic domain.

In the activation layer, activation functions including but not limited to argmax, Rectified Linear Unit (ReLU), sigmoid and tanh are converted. In the argmax function, the comparison operator in the logarithmic domain was used to get the position of the highest number. As ReLU is a piece-wise linear function, it was converted it to the logarithmic domain by using the sign attribute of a log number. The pseudo code below shows the conversion

```
in ReLU layer,
int LNS_ReLU(int log_number)
{
  if sign(log_number)==1
  //For negative number,
  ReLU outputs 0
    return LOG(0)
  else
    return log_number
}
```

Since sigmoid and tanh are non-linear functions, converting them to the logarithmic domain is not straightforward. To implement them in the logarithmic domain, lookup tables (LUT) are used. For the keys of the LUT, a range of numbers are selected based on the range and granularity of the distribution of weights and biases. Table 2 shows LUT with range (−M, M) and least-count of ε. [symbol] is sigmoid or tanh. For example, the range is selected as (5,5) and granularity as 0.0001. For each key, the sigmoid or tanh function of that key is first computed. Then, log(key) and log(value) as the key and value are stored in the LUT as shown in Table 3. To search an element in the LUT, its log is computed and then a binary search operation is performed to get the nearest key from LUT. The corresponding value is returned as logarithmic of sigmoid/tanh function of the searched element.

TABLE 2

| Key | Value |
|---|---|
| −M | [symbol] (−M) |
| −M + ε | [symbol] (−M + ε) |
| −M + 2 ε | [symbol] (−M + 2 ε) |
| . . . | . . . |
| M − ε | [symbol] (M − E) |
| M | [symbol] (M) |

TABLE 3

| Key′ | Value′ |
|---|---|
| log (−M) | log( [symbol] (−M)) |
| log (−M + ε) | log ( [symbol] (−M + ε)) |
| log (−M + 2 ε) | log ( [symbol] (−M + 2 ε)) |
| . . . | . . . |
| log (M − ε ) | log ( [symbol] (M − ε)) |
| log (M) | log ( [symbol] (M)) |

A basic LSTM layer is converted into the logarithmic domain. An LSTM cell has four gates: input modulation gate, input gate, forget gate and output gate. For the LSTM layer, apart from input, weights and biases, the previous cell and hidden states are converted to the logarithmic domain. The core computation of each gate is similar to that of the dense layer, namely, A*W+b. Hence, the multiplication and addition operations are converted into the logarithmic domain.

At step 306 of the method 300, the one or more hardware processors 102 are configured to perform NN inference with an input data to obtain a set of output using the logarithmic neural network. The input data is converted into logarithmic domain using the BMLNS technique. The set of output data is in logarithmic domain. However, it may be converted back to real domain with respect to the neural network application. If the NN is pre-trained in logarithmic domain, the NN is performed inferencing without performing the steps under 304. The NN inferencing is performed by converting the neural network layer-wise operations using the input data which is converted into logarithmic domain.

EXPERIMENTAL RESULTS: The disclosed method was implemented in several networks, from both computer vision and natural language processing, and both small and large in the logarithmic domain. The software used are Python 3.6.9, Keras. Few networks used for implementation are multi-layer perceptron (MLP), LeNet network, VGG16 network, Residual Network 50 (ResNet50) network, LSTM network.

Multi-layer perceptron (MLP): An MLP model is trained on the MNIST dataset. For logarithmic domain inference, a dense layer only is needed to implement in the logarithmic domain. It was observed that the results in the real domain match 100% with those obtained in the logarithmic domain.
LeNet network: The LeNet network is trained on the MNIST dataset. The network has three layers: 2d convolution layer (Conv2d), maxpool and dense layers, which were implemented in the logarithmic domain. The logarithmic domain accuracy results were found to match 100% with those obtained in the real domain.
VGG16 network: The VGG16 network is trained on the ImageNet dataset. VGG16 has a combination of 3 layers, namely, 2d-convolution, max-pooling and dense layers.
10, 000 test images were evaluated from ImageNet using VGG16 in the real and log domains. With real domain implementation, the accuracy is found to be around 91.4%.
With logarithmic domain implementation, the accuracy is found to be around 91.2%. Upon comparing 10000 results predicted by the real domain and log domain VGG16, it is observed that 26 different results and the rest are the same. The difference arises from the fact that VGG16 is a deep network, and even minor approximations due to the limited storage capacity of computers can change output activations of intermediate layers. Since the ImageNet dataset has 1000 classes, even a negligible difference in the activations of the last few layers can change the final prediction. However, the difference in accuracy is negligible.
ResNet50 network: ResNet50 is trained on the sign language digits dataset, which has 6 classes. ResNet50 combines four layers: Conv2d, batch-normalization, ReLU activation and dense layer. These layers were converted into the logarithmic domain. The inference results in the logarithmic domain were found to match 100% with those in the real domain.
LSTM network: A basic LSTM model is taken consisting of an LSTM cell and a dense layer trained on time-series data. It was implemented in the logarithmic domain and was observed that its results match 100% with those obtained.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiment of present disclosure herein provides a method for NN inferencing in logarithmic domain. The method uses logarithm domain, which mitigate the multiplication bottleneck in the inference part of deep learning model. The embodiment thus provides a bit manipulation based logarithm number system technique for converting a pre-trained NN into logarithmic domain wherein the NN is pre-trained in real domain or in logarithmic domain. The embodiments of the disclosed method converts the neural network weights, neural network layers and activation function of the pre-trained NN into logarithmic domain using the BMLNS technique. The method uses a 32-bit integer variable to store the three variables of a logarithm number, magnitude, sign and iszero which increases memory efficiency of the disclosed method as compared to the conventional techniques.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method comprising:
receiving, via one or more hardware processors, a neural network (NN) comprising (i) a plurality of neural network weights, (ii) a plurality of neural network layers comprising a plurality of neural network layer-wise operations and (iii) a plurality of activation functions in an activation layer of the NN;
converting, via the one or more hardware processors, the NN into logarithmic domain to obtain a logarithmic neural network using a Bit Manipulation based Logarithmic Number System (BMLNS) technique wherein the step of converting comprises,
converting the plurality of neural network weights of the NN into a logarithmic domain to obtain a plurality of logarithmic neural network weights using the BMLNS technique;
converting the plurality of neural network layers and the plurality of activation functions into the logarithmic domain to obtain a plurality of logarithmic neural network layers and a plurality of logarithmic activation functions using the BMLNS technique;
and
performing, via the one or more hardware processors, the NN inference with an input data to obtain a set of output using the logarithmic neural network wherein the input data is converted into logarithmic domain using the BMLNS technique.

2. The method as claimed in claim 1, wherein the NN is pre-trained in one of (i) a real domain and (ii) the logarithmic domain.

3. The method as claimed in claim 1, wherein the BMLNS technique on a real number(x) is denoted by,
$$mag = log ( \vert x \vert ) \\ number = ( ( int ( \vert mag \vert \times {2}^{n} ) \times 2 + sign ) \times 2 + iszero ) \\ BMLNS = \{ \begin{matrix}number , & if mag \geq 0 \\ - ( number ) , & otherwise\end{matrix}$$
where, sign denotes sign of the real number, iszero denotes the real number is zero or otherwise, mag is the magnitude of logarithmic number system representation of the real number and n is a positive integer decided on real time based on the granularity and distribution of neural network weights of the pre-trained NN.

4. The method as claimed in claim 1, wherein the real number is transformed to a single 32-bit integer using the bit manipulation based logarithmic number system.

5. The method as claimed in claim 4, wherein the single 32-bit integer of the real number comprises,
a least significant bit (LSB) denoting the real number is zero or otherwise;
a bit before LSB denoting sign of the real number; and
remaining bits denoting integer value of magnitude of logarithm function of the real number.

6. The method as claimed in claim 1, wherein the plurality of neural network layers includes an input layer, a dense layer, a convolution layer, a max-pooling layer, a batch normalization layer, an activation layer and a Long Short Term Memory (LSTM) layer.

7. The method as claimed in claim 1, wherein the plurality of activation functions includes an argmax function, a Rectified Linear Unit (ReLU) function, a sigmoid and a tanh function.

8. The method as claimed in claim 1, wherein converting the plurality of activation functions utilizes anyone of (i) BMLNS technique or (ii) a pre-computed lookup table.

9. A system comprising:
a memory storing instructions;
one or more communication interfaces; and
one or more hardware processors coupled to the memory via the one or more communication interfaces, wherein the one or more hardware processors are configured by the instructions to:
receive a neural network (NN) comprising (i) a plurality of neural network weights, (ii) a plurality of neural network layers comprising a plurality of neural network layer-wise operations and (iii) a plurality of activation functions in an activation layer of the NN;
convert the NN into a logarithmic domain to obtain a logarithmic neural network using a Bit Manipulation based Logarithmic Number System (BMLNS) technique wherein the step of converting comprises,
converting the plurality of neural network weights of the NN into the logarithmic domain to obtain a plurality of logarithmic neural network weights using BMLNS technique;
converting the plurality of neural network layers and the plurality of activation functions into the logarithmic domain to obtain a plurality of logarithmic neural network layers and a plurality of logarithmic activation functions using BMLNS technique;
and
perform the NN inference with an input data to obtain a set of output using the logarithmic neural network wherein the input data is converted into logarithmic domain using the BMLNS technique.

10. The system as claimed in claim 9, wherein the NN is pre-trained in one of (i) a real domain and (ii) the logarithmic domain.

11. The system as claimed in claim 9, wherein the BMLNS technique on a real number(x) is denoted by,
$$mag = log ( \vert x \vert ) \\ number = ( ( int ( \vert mag \vert \times {2}^{n} ) \times 2 + sign ) \times 2 + iszero ) \\ BMLNS = \{ \begin{matrix}number , & if mag \geq 0 \\ - ( number ) , & otherwise\end{matrix}$$
where, sign denotes sign of the real number, iszero denotes the real number is zero or otherwise, mag is the magnitude of logarithmic number system representation of the real number and n is a positive integer decided on real time based on the granularity and distribution of neural network weights of the pre-trained NN.

12. The system as claimed in claim 9, wherein the real number is transformed to a single 32-bit integer using the bit manipulation based logarithmic number system.

13. The system as claimed in claim 12, wherein the single 32-bit integer of the real number comprises,
a least significant bit (LSB) denoting the real number is zero or otherwise;
a bit before LSB denoting sign of the real number; and
remaining bits denoting integer value of magnitude of logarithm function of the real number.

14. The system as claimed in claim 9, wherein the plurality of neural network layers includes an input layer, a dense layer, a convolution layer, a max-pooling layer, a batch normalization layer, an activation layer and a Long Short Term Memory (LSTM) layer.

15. The system as claimed in claim 9, wherein the plurality of activation functions includes an argmax function, a Rectified Linear Unit (ReLU) function, a sigmoid and a tanh function.

16. The system as claimed in claim 9, wherein converting the plurality of activation functions utilizes anyone of (i) BMLNS technique or (ii) a pre-computed lookup table.

17. One or more non-transitory machine-readable information storage mediums comprising one or more instructions which when executed by one or more hardware processors cause:
receiving a neural network (NN) further comprising (i) a plurality of neural network weights, (ii) a plurality of neural network layers comprising a plurality of neural network layer-wise operations and (iii) a plurality of activation functions in an activation layer of the NN;
converting the NN into logarithmic domain to obtain a logarithmic neural network using a Bit Manipulation based Logarithmic Number System (BMLNS) technique wherein the step of converting comprises,
converting the plurality of neural network weights of the NN into a logarithmic domain to obtain a plurality of logarithmic neural network weights using the BMLNS technique;
converting the plurality of neural network layers and the plurality of activation functions into the logarithmic domain to obtain a plurality of logarithmic neural network layers and a plurality of logarithmic activation functions using the BMLNS technique;
and
performing the NN inference with an input data to obtain a set of output using the logarithmic neural network wherein the input data is converted into logarithmic domain using the BMLNS technique.

18. The one or more non-transitory machine-readable information storage mediums of claim 17, wherein the NN is pre-trained in one of (i) a real domain and (ii) the logarithmic domain.

19. The one or more non-transitory machine-readable information storage mediums of claim 17, wherein the BMLNS technique on a real number(x) is denoted by,
$$mag = log ( \vert x \vert ) \\ number = ( ( int ( \vert mag \vert \times {2}^{n} ) \times 2 + sign ) \times 2 + iszero ) \\ BMLNS = \{ \begin{matrix}number , & if mag \geq 0 \\ - ( number ) , & otherwise\end{matrix}$$
where, sign denotes sign of the real number, iszero denotes the real number is zero or otherwise, mag is the magnitude of logarithmic number system representation of the real number and n is a positive integer decided on real time based on the granularity and distribution of neural network weights of the pre-trained NN.

20. The one or more non-transitory machine-readable information storage mediums of claim 17, wherein the real number is transformed to a single 32-bit integer using the bit manipulation based logarithmic number system.
